(19) United States
(12) Patent Application Publication
(10) Pub. No.: US 2014/0204528 A1
(43) Pub. Date: Jul. 24, 2014

(54) PORTABLE COMPUTER

(71) Applicant: HON HAI PRECISION INDUSTRY CO., LTD., New Taipei (TW)

(72) Inventors: WEN-CHI HUANG, New Taipei (TW); CHIA-WEI TING, New Taipei (TW)

(73) Assignee: HON HAI PRECISION INDUSTRY CO., LTD., New Taipei (TW)

(21) Appl. No.: 14/140,490

(22) Filed: Dec. 25, 2013

(30) Foreign Application Priority Data
Jan. 24, 2013 (TW) 102102614

(51) Int. Cl. G06F 1/16

(52) U.S. Cl. CPC G06F 1/1635
USPC 361/679.55

(57) ABSTRACT

A portable computer includes a main body, a battery, a back shell, and a latch. The battery is attached to the main body. The battery defines a latching slot. The latch extends from an inner surface of the back shell. The latch is inserted into the latching slot of the battery, so that the back shell is mounted to the main body and covers the battery.

### REFERENCE TO RELATED APPLICATIONS

This application claims all benefits accruing under 35 U.S.C. §119 from Taiwan Patent Application No. 102102614 filed on Jan. 24, 2013 in the Taiwan Intellectual Property Office, the contents of the Taiwan Application are hereby incorporated by reference.

### BACKGROUND

1. Technical Field

The present disclosure generally relates to portable computers, and particularly relates to portable computers having a battery and a back shell.

2. Description of Related Art

A portable computers (or a notebook computer) typically includes a battery that is charged and stores energy from an external alternating current to a direct current (AC/DC) adapter. Generally, the battery is attached to the main body of the portable computer and a back shell is mounted to the main body by screws to cover the battery for protection purposes. However, mounting the back shell with screws may be complicated and time-consuming.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a portable computer.

FIG. 2 is similar to FIG. 1, but viewed from another aspect.

FIG. 3 is an exploded, isometric view of a battery of the portable computer of FIG. 2.

FIG. 4 is an enlarged view of circled portion IV of FIG. 3.

FIG. 5 is a cross sectional view taken along a line V-V of FIG. 3.

FIG. 6 is an enlarged view of circled portion VI of FIG. 1.

FIG. 7 is a cross sectional view taken along a line VII-VII of FIG. 1.

FIG. 8 is an assembled view of the portable computer of FIG. 1.

FIG. 9 is similar to FIG. 8, but viewed from another aspect.

FIG. 10 is a cross sectional view taken along a line X-X of FIG. 9.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

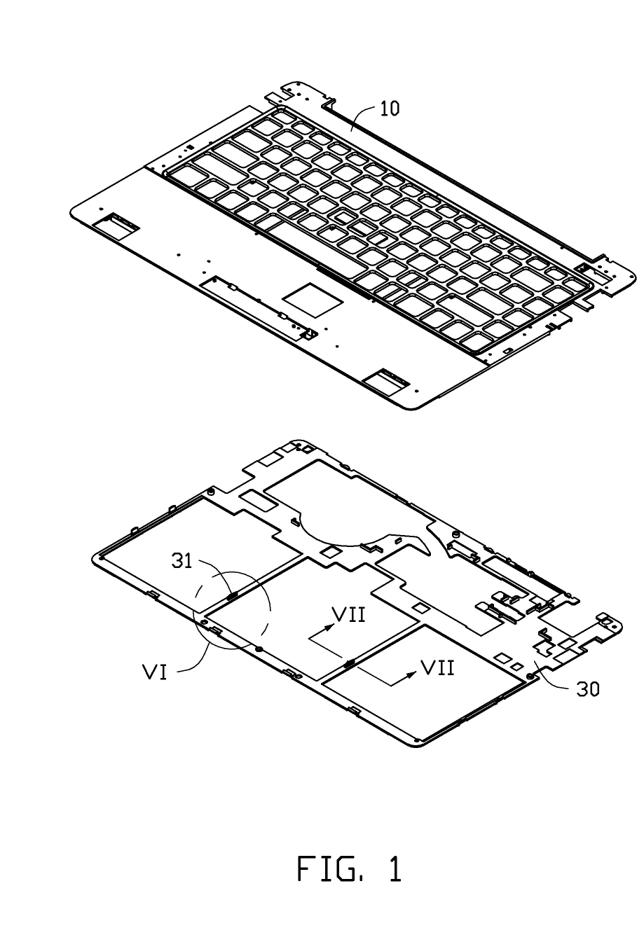

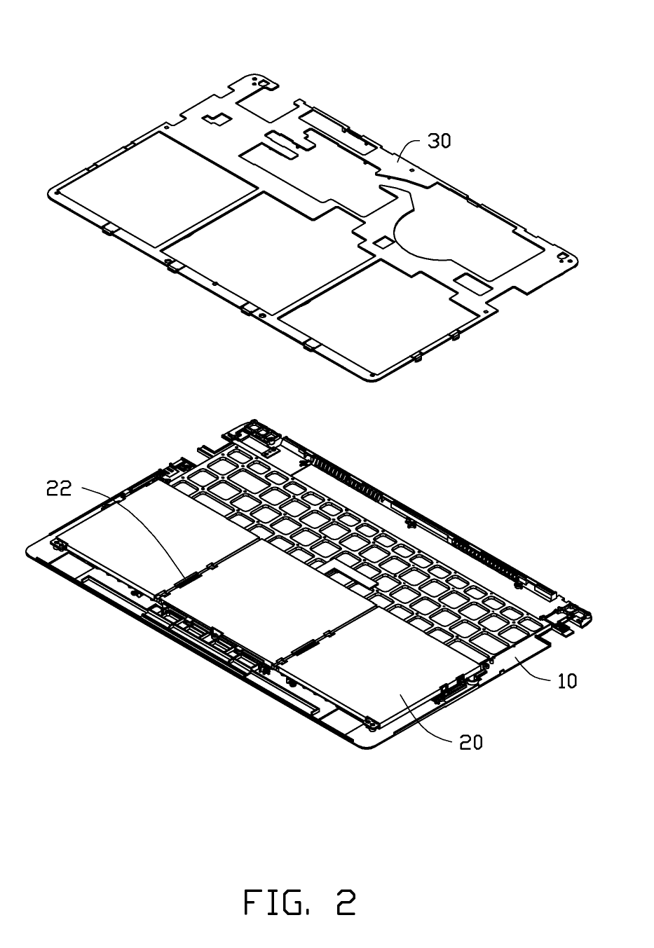

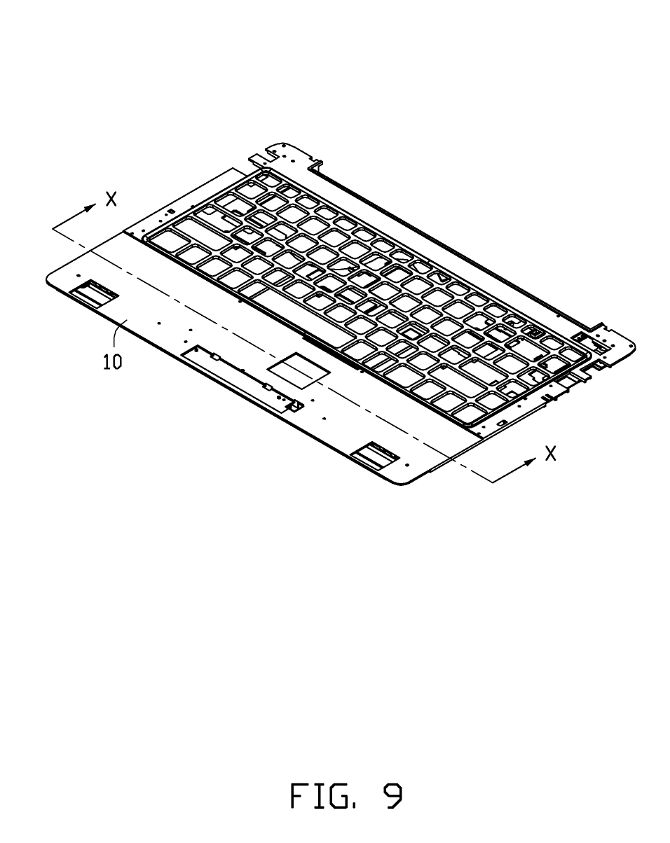

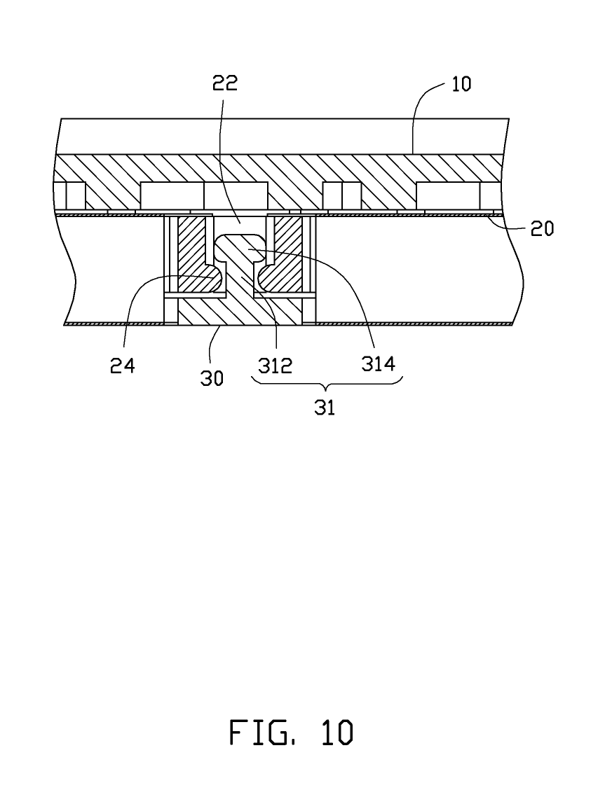

FIGS. 1-10 show an embodiment of a portable computer. The portable computer includes a main body 10, a battery 20, and a back shell 30.

The main body 10 may include a mother board, a central processing unit (CPU), a random access memory (RAM), a read-only memory (ROM), a network interface card (NIC), a hard disk drive, and other components.

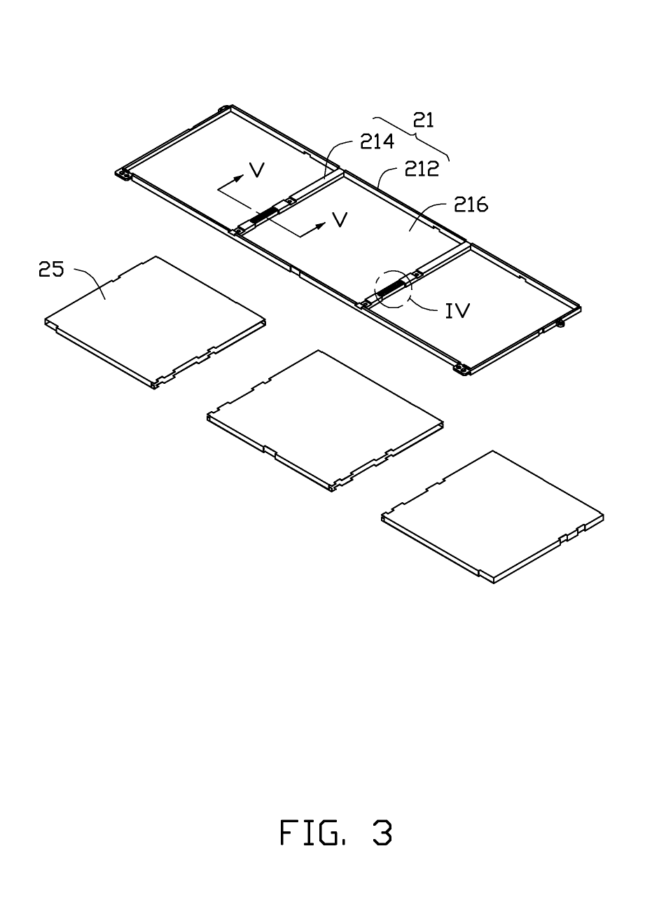

Referring to FIGS. 3-5, the battery 20 includes a battery frame 21 and a plurality of battery cells 25. The battery frame 21 includes an outer frame 212 and a plurality of isolation bars 214. Each of the plurality of isolation bars 214 interconnects two opposite rims of the battery frame 21. The battery frame 21 and the plurality of isolation bars 214 cooperatively form a plurality of grids 216. Each of the plurality of battery cells 25 is received in one of the plurality of grids 216. The plurality of isolation bars 214 is parallel to each other. The plurality of isolation bars 214 isolates the plurality of battery cells 214 from each other, so that the heat generated by one battery cell 214 is prevented from being directly transferred to other battery cells 214.

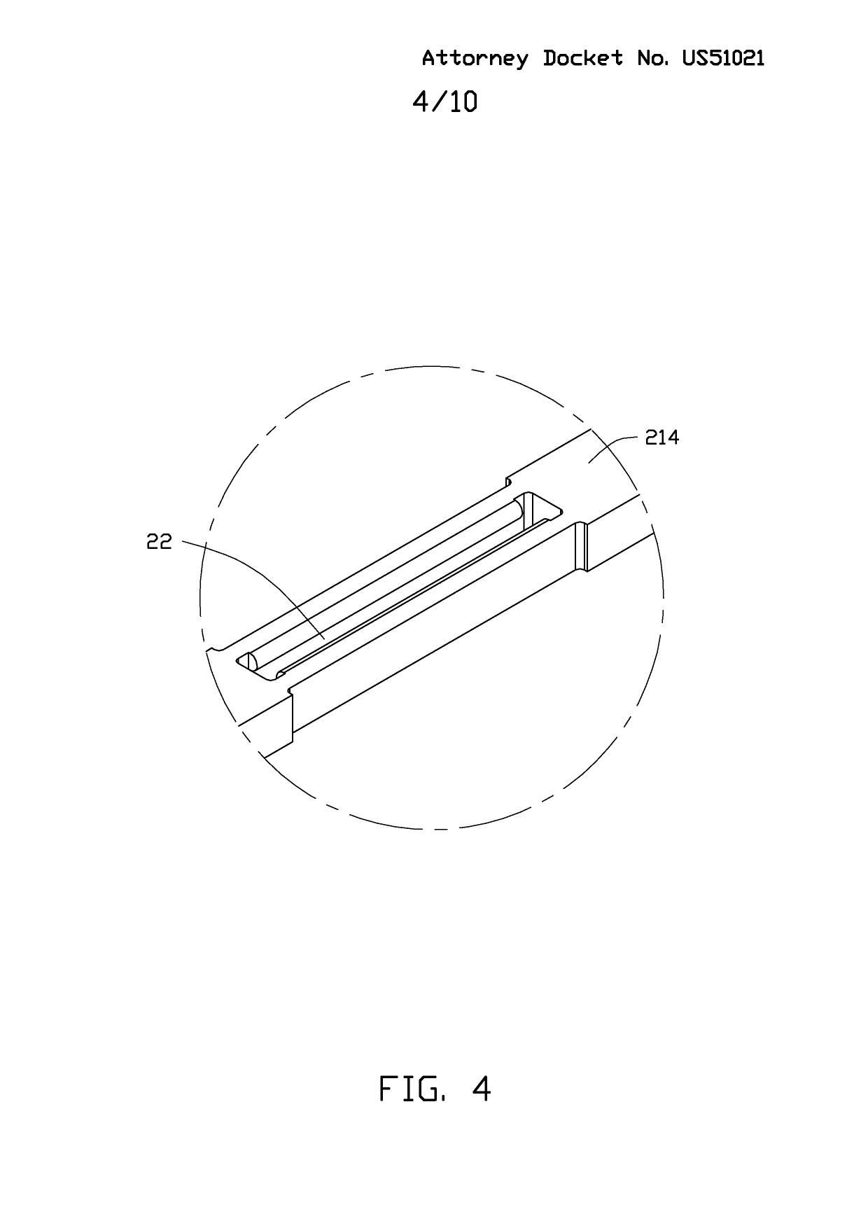

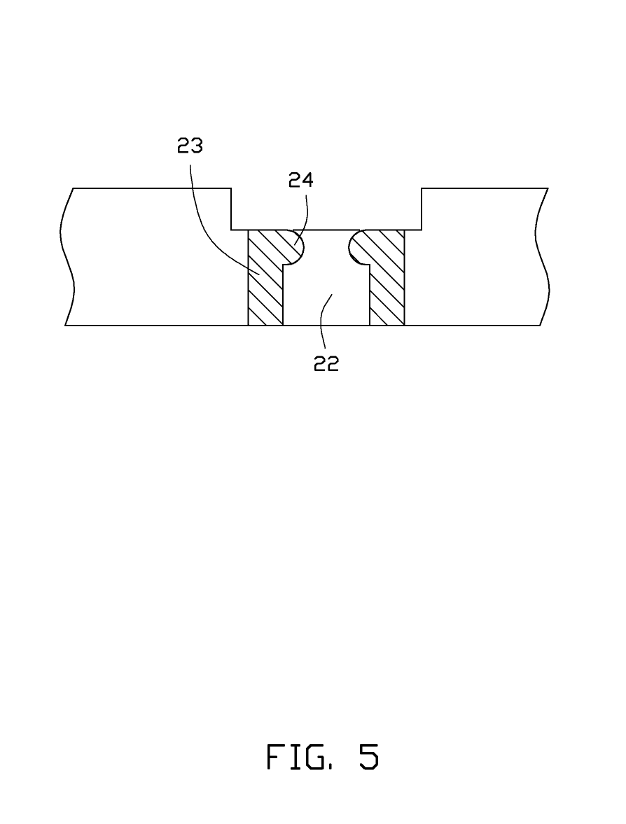

A latching slot 22 is defined in each of the plurality of isolation bars 214. The latching slot 22 extends along a longitudinal direction of the isolation bar 214. Referring to FIGS. 4 and 5, the latching slot 22 includes two sidewalls 23. A limiting rib 24 protrudes from each of the two sidewalls 23. In one embodiment, an outer surface of the limiting rib 24 is curved.

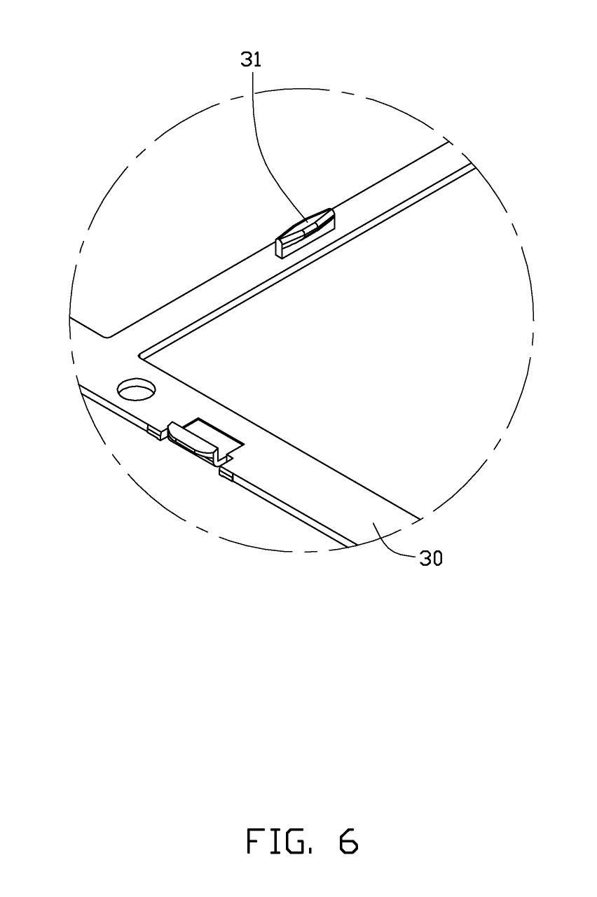

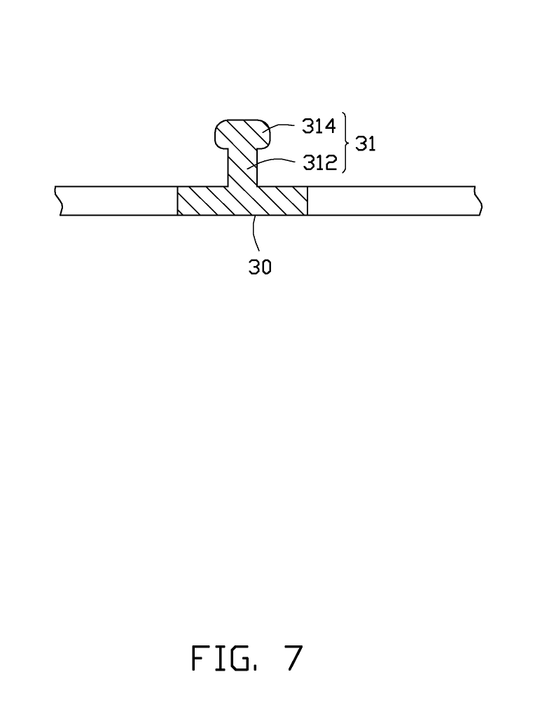

A plurality of latches 31 protrudes from an inner surface of the back shell 30. Referring to FIGS. 6 and 7, the latch 31 includes a neck portion 312 and a head portion 314. The neck portion 312 extends from the inner surface of the back shell 30. The head portion 314 extends from the neck portion 312. A width of the head portion 314 is greater than that of the neck portion 312. The width of the head portion 314 is greater than a distance between the two opposite limiting ribs 24 of the latching slot 22. In one embodiment, a side surface of the head portion 314 is curved.

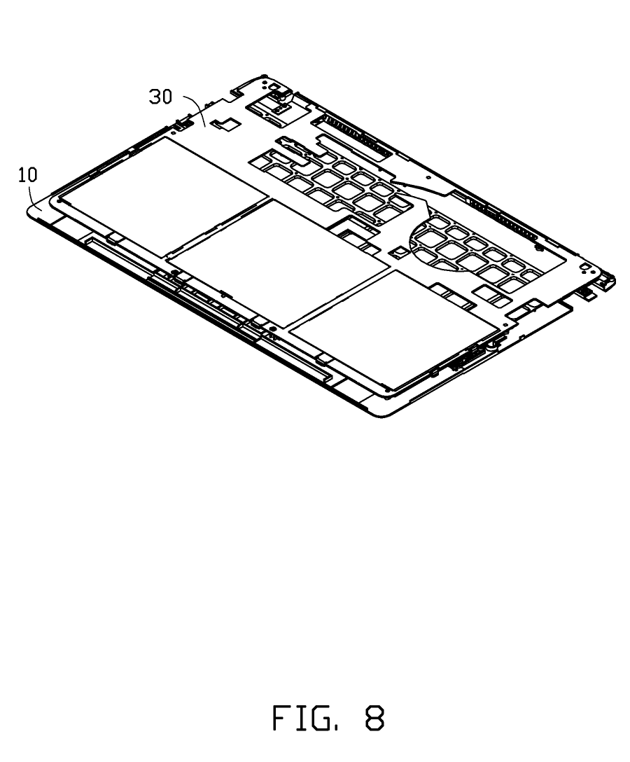

Referring to FIGS. 8-10, in assembly, the battery 20 is attached to the main body 10. Each latch 31 of the back shell 30 is aligned with one of the plurality of latching slot 22 of the battery 20. The head portion 314 of the latch 31 deforms the two limiting ribs 24 and then is inserted into the latching slot 22. The plurality of latches 31 of the back shell 30 is engaged in the plurality latching slot 22 of the battery 20, so that the back shell 30 is mounted to the main body 10 and covers the battery 20.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A portable computer, comprising:
a main body;
a battery attached to the main body, the battery defining a latching slot;
a back shell configured to cover the battery; and
a latch extending from an inner surface of the back shell, wherein the back shell is mounted to the main body by inserting the latch into the latching slot of the battery.

2. The portable computer of claim 1, wherein the latching slot comprises two sidewalls, a limiting rib protrudes from each of the two sidewalls.

3. The portable computer of claim 2, wherein an outer surface of the limiting rib is curved.

4. The portable computer of claim 2, wherein the latch comprises a neck portion extending from the inner surface of the back shell and a head portion extending from the neck portion, a width of the head portion is greater than a width of the neck portion.

5. The portable computer of claim 4, wherein the width of the head portion is greater than a distance between the two limiting ribs.

6. The portable computer of claim 5, wherein a side surface of the head portion is curved.

7. The portable computer of claim 1, wherein the battery comprises a battery frame and a plurality of battery cells mounted in the battery frame, and the battery frame defines the latching slot.

8. The portable computer of claim 7, wherein the battery frame comprises an outer frame and a plurality of isolation bars, each of the plurality of isolation bars interconnects two opposite rims of the battery frame, the outer frame and the plurality of isolation bars cooperatively form a plurality of grids configured to accommodate the plurality of battery cells.

9. The portable computer of claim 8, wherein the latching slot is defined in one of the plurality of isolation bars.

10. The portable computer of claim 9, wherein the plurality of isolation bars is parallel to each other.

11. The portable computer of claim 9, wherein the latching slot extends along a longitudinal direction of one of the plurality of isolation bars.

12. A portable computer, comprising:
a main body;
a battery frame attached to the main body, the battery frame defining a latching slot and being configured to receive a plurality of battery cells;
a back shell configured to cover the plurality of battery cells; and
a latch extending from an inner surface of the back shell, wherein the back shell is mounted to the main body by inserting the latch into the latching slot of the battery frame.

13. The portable computer of claim 12, wherein the battery frame comprises an outer frame and a plurality of isolation bars, each of the plurality of isolation bars interconnects two opposite rims of the battery frame, the outer frame and the plurality of isolation bars cooperatively form a plurality of grids configured to accommodate the plurality of battery cells.

14. The portable computer of claim 13, wherein the latching slot is defined in one of the plurality of isolation bars.

15. The portable computer of claim 14, wherein the latching slot extends along a longitudinal direction of one of the plurality of isolation bars.

16. The portable computer of claim 12, wherein the latching slot comprises two sidewalls, a limiting rib protrudes from each of the two sidewalls.

17. The portable computer of claim 16, wherein an outer surface of the limiting rib is curved.

18. The portable computer of claim 16, wherein the latch comprises a neck portion extending from the inner surface of the back shell and a head portion extending from the neck portion, a width of the head portion is greater than a width of the neck portion.

19. The portable computer of claim 18, wherein the width of the head portion is greater than a distance between the two limiting ribs.

20. The portable computer of claim 19, wherein a side surface of the head portion is curved.
